(19) United States
(12) Patent Application Publication
(10) Pub. No.: US 2023/0140406 A1
(43) Pub. Date: May 4, 2023

(54) COMPUTER AND OPERATING SYSTEM FOR INTERNATIONAL DIGITAL CURRENCY CONVERSION MANAGEMENT, AND METHOD THEREFOR

(71) Applicant: Seong Min YOON, Guri-si (KR)

(72) Inventor: Seong Min YOON, Guri-si (KR)

(21) Appl. No.: 17/920,101

(22) PCT Filed: Apr. 20, 2021
(86) PCT No.: PCT/KR2021/004915

§ 371 Date: Oct. 20, 2022

(30) Foreign Application Priority Data
Apr. 27, 2020 (KR) 10-2020-0050519

(51) Int. Cl. G06Q 40/04; G06Q 20/38

(52) U.S. Cl. CPC G06Q 40/04; G06Q 20/381

(57) ABSTRACT

The present invention relates to a computer and an operating system for international digital currency conversion management, and a method therefor. More particularly, the present invention relates to a computer and an operating system for international digital currency conversion management, and a method therefor, which can convert an existing currency into an international digital currency that can be used between countries without paying a fee, and in converting the currency into international digital currency, secure the security of financial transactions by performing the applicant's identity authentication through identity authentication of multiple applicants, determining whether to approve the conversion of the applicant by a predetermined number of non-related persons from a predetermined number of other countries not related to the applicant, and improving the reliability of international digital currency and activating the use of international digital currency.

### BACKGROUND OF THE INVENTION

### Field of the Invention

The present invention relates to a computer and an operating system for international digital currency conversion management, and a method therefor. More particularly, the present invention relates to a computer and an operating system for international digital currency conversion management, and a method therefor, which can convert an existing currency into an international digital currency that can be used between countries without paying a fee, and in converting the currency into international digital currency, secures the security of financial transactions by performing the applicant's identity authentication through identity authentication of multiple applicants, determining whether to approve the conversion of the applicant by a predetermined number of non-related persons from a predetermined number of other countries not related to the applicant, and improving the reliability of international digital currency and activating the use of international digital currency.

### Description of Related Art

Although cryptocurrency using block chain has been developed, it is difficult to commercialize it due to the limitations of technology, which makes it difficult to quickly process large-scale transactions. Because the powers that create and operate blocks are specified, it has a structure that makes it difficult for ordinary people to participate in system operation, and there is a problem that it is used as a means of payment for various illegal or criminal acts based on anonymity.

Recently, CBDC (Central Bank Digital Currency) has been the subject of research around the world, and interest is high enough that China has already announced a specific issuance plan. However, this is nothing more than the online conversion of a specific country's monetary system. Since CBDC itself is based on the monetary system of a specific country, there is a limitation in that it does not function as a universal currency. In addition, as the central axis has recently shifted to online transactions rather than offline transactions, the use of offline currency is decreasing and online account transfer transactions are increasing, the use of digital currency in a specific country has no special meaning other than omitting the printing or production of currency in a specific country.

In modern times, it is customary to exchange the currency for each country into the currency of a specific country and settle the payment in the domestic currency circulation as well as in the commerce between countries. However, there is a problem in that a process of exchanging money by applying the exchange rate at each point in time is required, and in this process, various transaction fees are generated and it takes a certain time to complete the settlement, so there is a problem in that intermediate costs or fees are excessively generated.

Therefore, there is a need for digital currency that can be used in common all over the world beyond a specific country. In this regard, the invention of the international electronic money system in Korean Patent Publication No. 10-2006-0099957 (published date: Sep. 20, 2006) is disclosed.

The disclosed invention is an international electronic money system including an international settlement server, an issuing country settlement server, and a user country settlement server connected to each other through a predetermined communication network, wherein the issuing country settlement server issues an electronic money card to the user, and charges a predetermined amount of electronic money to the electronic money card according to the exchange rate information scheduled for the exchange rate, and pays the first settlement amount corresponding to the settlement request information received from the international settlement server to the international settlement server, wherein the user country settlement server transmits the electronic money settlement details information transferred from the electronic money card issued by the issuing country settlement server to the user country settlement server according to the usage exchange rate information for the user country to the international settlement server, and receives the second settlement amount corresponding to the settlement details information from the international settlement server, and wherein the international settlement server transmits the scheduled exchange rate information for each country and the exchange rate information used for each country to the settlement server of each country, and uses the settlement details information received from the settlement server of each country to obtain the first settlement amount and the second settlement amount is calculated, the settlement request information requesting payment of the first settlement amount is transmitted to the settlement server of each country, and the second settlement amount is paid to the settlement server of each country.

In addition, the invention of a method for intermediation of foreign exchange dealings through the medium of digital assets based on block-chain technology including crypto currency in Korean Patent Publication No. 10-2019-0091211 (published on Aug. 5, 2019) is disclosed.

The disclosed invention relates to a method of currency exchange and foreign exchange transaction using a blockchain-based digital asset including cryptocurrency as a medium. The exchange method of the disclosed invention uses an environment in which different currencies are traded within one exchange, excluding the method of transferring blockchain-based digital assets between exchanges, which has a long waiting time, an environment in which multiple exchanges transacting with different currencies share the digital assets through contracts, etc., or an environment that shares transaction information between exchanges even if the digital assets are not directly shared to create a foreign exchange market using the digital asset as a medium in a blockchain-based digital asset exchange, and the consumer directly applies the market's buy-sell spread to exchange easily and quickly without economic loss do.

Since the disclosed invention of international electronic money system is a transfer from offline to online where the conventional currency of a specific country is converted into an exchange rate related to the currency of each country, there is a limit to improving the reliability of electronic money and activating the use between countries.

In addition, the disclosed invention related to the exchange of cryptocurrency and foreign exchange, which converts the block-chain-based cryptocurrency into a heterogeneous currency, has a problem in that there is a limitation in its effectiveness in activating the reliability of electronic money and the use of cross-border use.

Therefore, there is a need for an invention, which can convert an existing currency into an international digital currency that can be used between countries without paying a fee, and in converting the currency into international digital currency, secures the security of financial transactions by performing the applicant's identity authentication through identity authentication of multiple applicants, determining whether to approve the conversion of the applicant by a predetermined number of non-related persons from a predetermined number of other countries not related to the applicant, and improving the reliability of international digital currency and activating the use of international digital currency.

### SUMMARY OF THE INVENTION

The present invention is conceived to solve the problems of the related art, and an object of the present invention provides a computer and an operating system for international digital currency conversion management, and a method therefor, which can convert an existing currency into an international digital currency that can be used between countries without paying a fee, and in converting the currency into international digital currency, secures the security of financial transactions by performing the applicant's identity authentication through identity authentication of multiple applicants, determining whether to approve the conversion of the applicant by a predetermined number of non-related persons from a predetermined number of other countries not related to the applicant, and improving the reliability of international digital currency and activating the use of international digital currency.

According to a first aspect of the present invention, An IDC conversion management computer comprising: at least one hardware processor and a memory storing a program for converting the specific currency into international digital currency (IDC) (hereinafter also referred to as “international digital currency (IDC)” or “IDC”) that causes the computer to perform: receiving, by the at least one hardware processor of the IDC conversion management computer, an application for conversion of a specific currency entered into an international digital currency (IDC) dedicated account by a user into an international digital currency (IDC); selecting, by the at least one hardware processor of the IDC conversion management computer, a predetermined number of countries to participate in whether or not to approve the conversion of the user's application for conversion to international digital currency (IDC), and performing conversion of the specific currency to international digital currency based on verification of the validity of the conversion application by a predetermined number of non-relevant person approval participants in the selected country.

According to a second of the present invention, an operating system for international digital currency (IDC) comprising: IDC systems including IDC account generation system for generating International digital currency (IDC) dedicated account for each country, which is a user authentication and identification number of the user for the user's use of international digital currency (IDC), a foreign exchange management system for managing the exchange of the user's currency into a desired foreign currency using the information of the international digital currency (IDC) dedicated account created in the IDC account generation system, an IDC conversion management system for managing conversion processing of a user's specific currency into international digital currency using the information of the international digital currency (IDC) dedicated account, and an IDC management system for managing profit information and conversion approval information or transaction information given to participants in the process of converting the user's specific currency into international digital currency; a user terminal for each country user performing user authentication of users using the international digital currency system, foreign currency exchange, conversion of used currency to international digital currency, profit management according to the use of international digital currency, and storage of shared information related to international digital currency in communication with the IDC systems; a cloud computing system for storing the use information related to international digital currency between the user terminal for each country and the IDC systems in the storage capacity given to the user of the user terminal for each country, and allowing the stored information to be accessed by the user terminal and the IDC systems for each country.

According to a third aspect of the present invention for an international digital currency, comprising: transmitting, by a user terminal, a user's user authentication request inputted to IDC user interface outputted or executed to the user terminal to IDC systems; storing, by the IDC systems, information on a user authentication generated based on user's identity verification information received by user's identity authentication request information and identity authentication means of user in association with the user information, and transmitting the information on a user authentication to the user terminal; transmitting, by the user terminal, IDC account generation request information input to the IDC user interface to the IDC systems in a state that the user terminal has received the user authentication approval information; generating, by the IDC systems, an IDC account using an IDC account generating means based on the IDC account generation request information, storing the IDC account information in association with user information, and transmitting the IDC account information to the user terminal; requesting, by the user terminal to communicate with the IDC systems, to convert a predetermined amount into international digital currency using the user's IDC account to the IDC systems; confirming, by the IDC systems, whether the currency requested to be converted into an international digital currency based on the user's IDC account information is a set key currency; transmitting, by the IDC systems, an exchange guidance to the key currency in the foreign currency exchange system to the user terminal when the currency requested to be converted into an international digital currency is not the key currency, converting the key currency to the international digital currency when the currency is the key currency; and distributing and storing, by the IDC systems, the conversion approval history information to the international digital currency in the user terminal of the user, the terminal of the non-related approved participant, and the IDC systems, wherein the conversion to the international digital currency includes: a) extracting, by the IDC systems, a set number of countries from among the countries to which the applicant for conversion to international digital currency does not belong in a set manner, extracting approved participants consisting of a set number of unrelated persons of the user of the extracted countries in a set manner, and requesting whether the user's application for conversion to international digital currency is approved; b) converting, by the IDC systems, the user's key currency to international digital currency when more than the set number of people agree to the approval after receiving the reply information of the approval participants of the unrelated persons, transmitting the converted international digital currency amount information to the user terminal.

According to a fourth aspect of the present invention for an international digital currency of the third aspect of the present invention, further comprising: calculating, by the IDC systems, the profit information to be provided to the user for conversion to international digital currency and the non-related approved participant, and storing or accumulating the calculated profit information in connection with the conversion applicant and the approved participant information.

### Advantageous Effects

According to the present invention, it is possible to convert an existing currency into an international digital currency that can be used between countries without paying a fee and secure of the security of financial transactions by performing a user authentication of the conversion applicant through identity authentication by a plurality of related persons of the conversion applicant. In addition, it is possible to improve the credibility of international digital currency and promote its use by making a decision on whether to approve the conversion of the conversion applicant by a predetermined number of non-related persons unrelated to the selected applicant in a predetermined number of countries excluding the country of the conversion applicant, and by sharing the ledger that records the details of approval for conversion to international digital currency to the applicant, non-related person approval participants, and the operating computer.

### BRIEF DESCRIPTION OF THE DRAWINGS

FIG. 1 is a schematic diagram illustrating an embodiment of an operating system of the International digital currency (IDC) of the present invention.

FIG. 2 is a schematic diagram illustrating an embodiment of an IDC account generation system that is a real part of an operating system of the International digital currency of the present invention.

FIG. 3 is a schematic diagram of an embodiment of a foreign currency exchange management system, which is a part of an operating system of the International digital currency of the present invention.

FIG. 4 is a schematic diagram illustrating an embodiment of an IDC conversion management system, which is a specification of an operating system of the International digital currency of the present invention.

FIG. 5 is a schematic diagram illustrating an embodiment of an IDC management system, which is a specification of an operation system of the International digital currency of the present invention.

FIG. 6 is a flowchart illustrating an operating method of the international digital currency according to an embodiment of the present invention.

### BEST MODE FOR IMPLEMENTATION OF THE INVENTION

As the best mode for carrying out the present invention, an IDC conversion management computer including at least one hardware processor, and a memory storing instructions that, when executed by at least one processor, cause to perform: receiving an application for conversion of a specific currency entered into an international digital currency (IDC) dedicated account by a user into an international digital currency (IDC); selecting a certain number of countries to participate in whether or not to approve the conversion with respect to the user's application for conversion to International digital currency (IDC); and performing the conversion of the specific currency into the international digital currency (IDC) based on verification of the validity of the conversion application by the approved participants made up of a predetermined number of non-related persons in the selected country.

### DETAILED DESCRIPTION OF THE PREFERRED EMBODIMENT

Hereinafter, an embodiment of the international digital currency operating system and method of the present invention will be described in detail with reference to the accompanying drawings. Terms used in the description of the embodiments of the present invention will be defined. Various computers and terminals used in the description of the present invention may have their own hardware configuration, or a computer program or web program that utilizes the hardware resources. In addition, for example, it may consist of each configuration of hardware included in various computers of the embodiments of the present invention used in the present invention, and may consist of a computer program or a web program that is stored and executed by utilizing the hardware resources of the computer. Preferably, the various computers including the account generation management computer and the IDC conversion management computer used in the embodiment of the present invention include at least one hardware processor and a memory storing a program as a component for performing the embodiment of the present invention. It is preferable that the at least one processor controls the execution of the program stored in the memory. In addition, the programs stored in the memory of the various computers are composed of a plurality of components for performing an embodiment of the present invention, and the components may be expressed as “˜part”, “˜module” or “˜unit”. In addition, “˜system” and “˜systems” used in the description of the present invention mean components including one or more components of a computer or terminal. However, it is not limited to that term. In addition, the ‘user interface’ described in the embodiment of the present invention may be a web program or an application program that is output or installed on a user terminal or a non-related terminal and executed.

In addition, the meanings of identity authentication, other countries, acquaintances, related persons, and non-related persons used in the embodiments of the present invention may be defined in the description of the embodiments below.

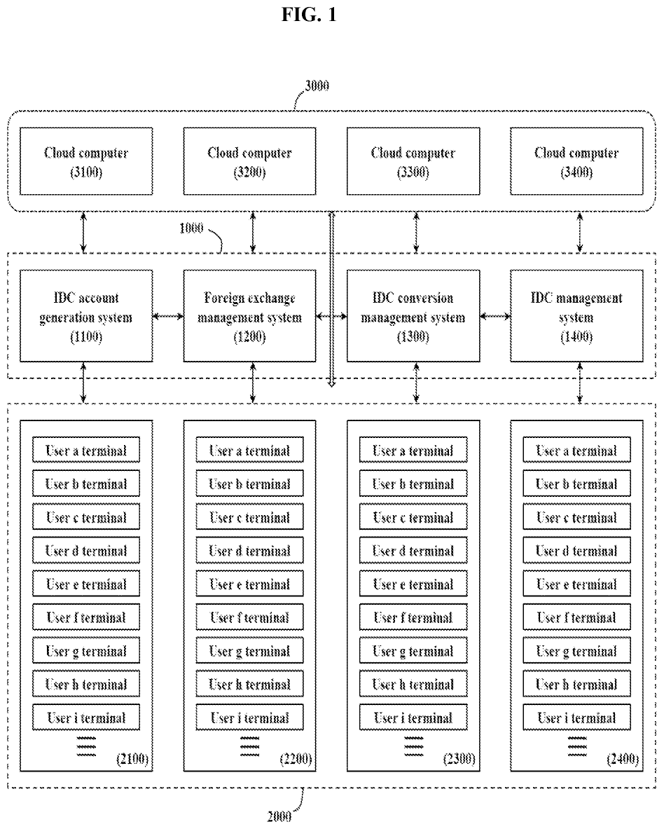

FIG. 1 is a schematic configuration diagram of an embodiment of the international digital currency operating system of the present invention.

As illustrated in FIG. 1, the international digital currency operating system of the present invention (hereinafter also referred to as ‘IDC system’) includes IDC systems 1000 including an IDC account generation system 1100 for performing user authentication for the user's use of international digital currency (IDC) and generating a country-specific international digital currency (IDC) dedicated account, which is an identification number, a foreign exchange management system 1200 for managing the exchange of the user's currency into a desired foreign currency using the information of the international digital currency (IDC) dedicated account generated in the IDC account generation system, an IDC conversion management system 1300 for managing conversion processing of a user's specific currency into international digital currency using the information of the international digital currency (IDC) dedicated account, and an IDC management system 1400 for managing profit information given to participants in the process of converting a specific currency into international digital currency in the IDC conversion management system 1300 and managing conversion approval information or transaction information; a user terminal 2000 of users of each country that is connected to the IDC systems 1000, for performing user's profit management according to the use of the IDC system of the present invention, including user authentication, foreign currency exchange, and conversion of used currency to international digital currency, and storing shared information related to international digital currency; and a cloud computing system 3000 for storing used information related to international digital currency between the user terminal 2000 of each country and IDC systems 1000 to the storage capacity granted to the user of the user terminal 2000 for each country, and providing the stored information so that the user terminal 2000 and the IDC systems 1000 for each country can access it.

The IDC account generation system 1100 of the IDC systems 1000 may be included an identity authentication means for user authentication requested from the user terminal and a means for generating an international digital currency (IDC) dedicated account of the user whose the user authentication has been completed.

The identity authentication means for the user authentication and the means for generating an International digital currency (IDC) dedicated account for the user whose user authentication has been completed may be configured of a computer or a server computer utilized respectively.

The foreign exchange management system 1200 is a means for users of each country to exchange their own currency into another country's currency, in particular, into a key currency, and may be configured of a computer or a server computer utilized respectively.

The IDC conversion management system 1300 is a means for users of each country to convert their own currency or key currency into international digital currency, and a means for managing exchange rate information between the key currency and international digital currency, and may be configured of a computer or a server computer utilized respectively.

The IDC management system 1400 for managing profit information provided by users of each country to international digital currency conversion applicants, approval participants in response to a request for conversion of key currency to international digital currency, and the IDC systems when converting the key currency into international digital currency, and information on the amount of excess conversion of international digital currency and advertising revenue in order to provide profits to them, may be configured of a computer that is utilized, respectively, and may be configured of a computer program or a web program that is stored and executed by utilizing hardware resources such as at least one hardware processor and memory that the computer has.

The user terminal 2000 of each country that is used by users who have registered as a member of the IDC systems 1000 for each country, including means for communication access to the IDC systems 1000 and operating means of programs and computer application programs (hereinafter referred to as ‘apps’), may be configured of a PC, a laptop computer, various mobile phones, mobile communication terminals, tablet computers, smartphones, etc.

The cloud computing system 3000 may be configured as an integrated system 3000, and may also be configured with cloud computers 3100 to 3400 for each country. The IDC systems 1000 provides a storage space for the use of the international digital currency system in connection with the user information of each country in the cloud computing system 3000 or the cloud computers 3100 to 3400 of each country, and the IDC The systems 1000 may provide user space information of the user's cloud computing system 3000 or cloud computers 3100 to 3400 to the user terminals 2000 of each country. Therefore, users of each country can utilize the storage space of the user terminal or the storage space of the cloud computing system to use various information related to the use of the international digital currency system.

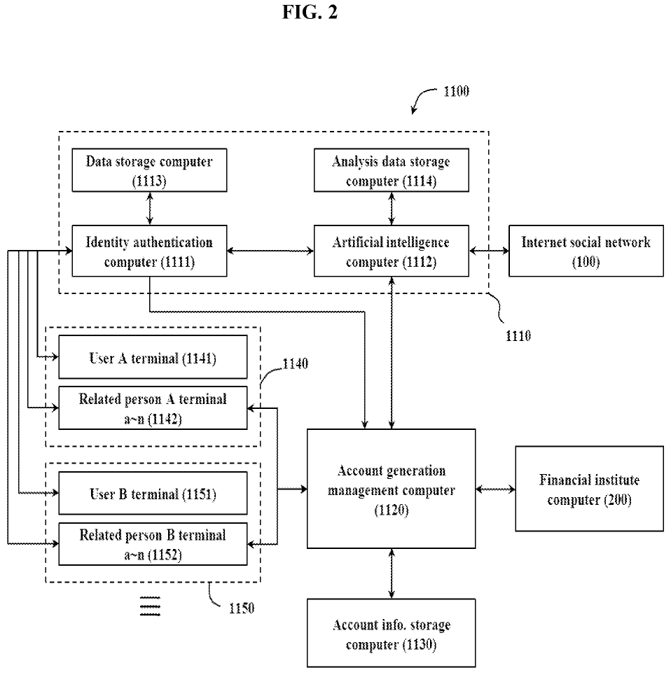

FIG. 2 is a schematic diagram illustrating an embodiment of an IDC account generation system that is a real part of an operating system of the International digital currency of the present invention.

As illustrated in FIG. 2, the IDC account generation system 1100 of the present invention includes an identity authentication unit 1110 for performing user authentication through identity authentication of related persons of the user when a user who wants to use international digital currency requests user authentication to generate an international digital currency (IDC) dedicated account, an internet social network 100 for inquiring information to be referenced for identity authentication in the identity authentication unit 1110, an account generation management computer 1120 for generating and storing an international digital currency (IDC) dedicated account of the user and transmitting the international digital currency (IDC) dedicated account to the user terminal, when a user whose user authentication has been completed in the identity authentication unit 1110 applies for an account opening to use international digital currency, a financial institution computer 200 that is communicatively connected to the account generation management computer 1120 and approves account generation in connection with the user's financial information, an account information storage computer 1130 for storing data including information on an international digital currency (IDC) dedicated account for each country generated for users of each country, a user A group 1140 including user A terminal 1141 used by user A which is connected to the identity authentication unit 1110 and the account generation management computer 1120, requests user authentication to the identity authentication unit 1110 and applies generation of international digital currency (IDC) dedicated account for each country to the account generation management computer 1120; and at least one related party terminal 1142 used by at least one related person such as an acquaintance of user A who is connected to communication with the identity authentication unit 1110 and can participate in the identity authentication related to the user authentication of the user, and a user B group 1150 having the same configuration as the user A group 1140. Here, at least one of the user group A 1140 and the user group B 1150 constitute a user group.

The identity authentication unit 1110 includes an identity authentication computer 1111 which receives and manages information on related person and a group of related person around requester of a user authentication, and manages the generated user authentication information and identity verification information, an artificial intelligence computer 1112 which forms a big data database by analyzing information such as words used in daily conversations and conversations between acquaintances collected through the Internet social network 100, receives communication details information of a group of related persons or related persons according to a request for identity verification from the identity verification computer 1111 and transmits the result of the identification verification to the operating computer, a data storage computer 1113 which stores data including a requester information of the user authentication managed by the identity authentication computer 1111, a related person group information, communication details information of a group of related persons and identity verification information transmitted from the artificial intelligence computer 1112, an analysis data storage computer 1114 which stores the big data database generated by collecting and analyzing the artificial intelligence computer 1112, information analyzed by the artificial intelligence computer 1112 on the communication details of the related person group or related persons received from the identity authentication computer 1111 and various data analysis of the artificial intelligence computer 1112 and statistics based thereon, a user authentication approval request means that is provided in the user terminal 1141 and 1151 of at least one requester, communicatively connected to the identity authentication computer 1111 and requests the user authentication and receives a user authentication approval information; and an identity verification data providing means that is provided in the at least one related person terminal 1142 and 1152 of related persons such as acquaintances who are related to the person who requested the user authentication, communicatively connected to the identity authentication computer 1111 and provides information such as relationship information and communication details with the identity authentication requester to the identity authentication computer 1111.

The identity authentication computer 1111 may be configured of at least one server computer having a communication means and capable of executing a computer program or a web program. The artificial intelligence computer 1112 may be configured of at least one server computer having a communication means and capable of executing an artificial intelligence (AI)-related computer program or web program. The data storage computer 1113 and the analysis data storage computer 1114 may be configured as a database management system (DBMS).

The user terminals 1141 and 1151 and the related person terminals 1142 and 1152 are provided with communication means, and may be configured as a terminal such as a smart phone, a tablet computer, a personal computer (PC), a laptop computer, etc. in which an application program or a web program can be executed.

The application program or web program provided by the user terminals 1141 and 1151 may be configured as a user authentication approval requesting means for requesting the user authentication approval from the identity authentication computer 1111. The application program or web program provided by the related person terminals 1142 and 1152 may be configured as an identity verification data providing means for providing a relationship information with requester of the user authentication and communication details etc. to the identity authentication computer 1111.

The Internet social network 100 is configured to include various social network services (SNS) and Internet media.

According to the above configuration of the present invention, the user terminals 1141 and 1151 request a user authentication of requester to the identity authentication unit. The identity authentication computer 1111 receives information of related persons such as acquaintances of the requester and communication information of related persons from the requester. The identity authentication computer 1111 requests and receives relation information and communication details information with the requester from the at least one related person terminal 1142, 1152 to confirm whether the requester is the same person from the related persons. The identity authentication computer 1111 transmits the received communication details information of the related persons to the artificial intelligence computer 1112 to request identity confirmation. The artificial intelligence computer 1112 determines the consistency of relationship data with the received relationship information and communication details information of related persons, and the relationship data collected from the internet social network 100 and generated and stored in the big data database. The artificial intelligence computer 1112 checks whether or not the identity is identical and transmits the identity verification information to the identity authentication computer 1111. The identity authentication computer 1111 transmits identity authentication approval information to the user terminals 1141 and 1151 based on the received identity verification information.

When the communication details information is voice information, it is possible to analyze the information using voice recognition technology to determine whether the voice matches or to analyze the corresponding information using a voice text conversion technique etc. The relationship information between the related persons and the authentication requester may include, for example, family members, relatives, friends, work colleagues, school classmates, social members, and acquaintances for hobby.

In addition, the communication details information of the related persons or group of related persons includes various types of communication information performed using a mobile phone, such as a mobile phone text message (SMS, MMS, etc.), a chat message in a chatting application program running on a mobile phone, and a text message on a social network service (SNS), e-mail letters, and internet voice calls on mobile phones.

In the embodiment of the identity authentication unit 1110 of the present invention, the function of the artificial intelligence computer 1112 is performed by the identity authentication computer 1111 and the artificial intelligence computer 1112 may be omitted.

The account generation management computer 1120 receives a generation request of an international digital currency (IDC) dedicated account for each country, which is a dedicated account for each country for using international digital currency using a user terminal of a user whose user verification has been completed in the identity verification unit 1110, generates the international digital currency (IDC) dedicated account for each country and store it in connection with the user information, and transmits the information of the generated international digital currency (IDC) dedicated account for each country to the user terminal.

The user terminal transmits, to the account creation management computer 1120, the setting information of the international digital currency (IDC) dedicated account for each country input by the user into the user interface of the output or executed IDC system to request the generation of the dedicated account.

The information of the international digital currency (IDC) dedicated account for each country generated in the account generation management computer 1120 may be configured as, for example, “KR02123456789101112 1” including “country information, regional information, unique number, and using country information”. Table 1 below shows an example of the inputted international digital currency (IDC) dedicated account setting information for each country.

TABLE 1

| Country | Regional | | Country | Reference |
|---|---|---|---|---|
| Infor- | Infor- | Unique | information | (by |
| mation | mation | Number | of use | country) |
| KR | 02 | 123456789101112 | 1 | US(USD) |
| | | | 2 | EP(EUR) |
| | | | 3 | CN(CNY) |

Referring to Table 1 above, the international digital currency (IDC) dedicated account opened by the user is based in Korea (KR) and Seoul (02), the account for US dollars is “KR02123456789101112 1”, and the account for Euros is “KR02123456789101112” 2”, the account for Chinese Yuan may be configured to include information such as “KR02123456789101112 3”.

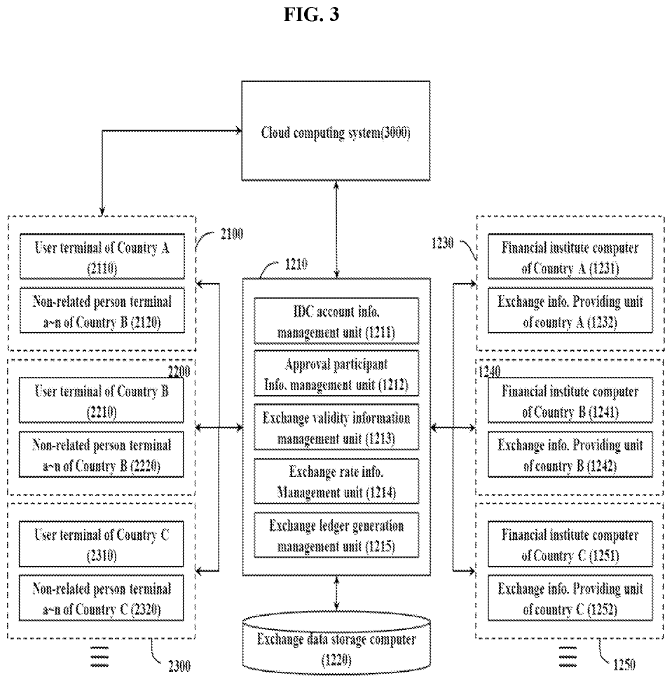

FIG. 3 is a schematic configuration diagram of an embodiment of a foreign exchange management system, which is a major part of the international digital currency operating system of the present invention.

As illustrated in FIG. 3, the foreign exchange management system 1200 of the present invention includes a foreign exchange management computer 1210 which manages the exchange of the requested currency in response to the exchange request of the user who is the holder of the international digital currency (IDC) dedicated account for each country; a currency exchange data storage computer 1220 which is included in the exchange management computer 1210 or is connected to a communication means and stores various data such as international digital currency (IDC) dedicated account of the user required for foreign exchange, and exchange rates for each country; and financial institution systems 1230, 1240 and 1250 for each country which provide information including financial accounts of users in each country who requested currency exchange, financial information necessary for currency exchange, and current exchange rate information to the foreign exchange management computer 1210.

In addition, the foreign exchange management system 1200 may further include a user groups 2100, 2200, 2300 for each country which is communicatively connected to the foreign exchange management computer 1210 including user terminals used by currency exchange requesters in each country and non-related terminals used by at least one non-related person not related to the user requesting currency exchange; and a cloud computing system 3000 which is communicatively connected to the foreign exchange management computer 1210 and the user groups 2100, 2200, 2300 for each country, and has a data storage space for the users for each country.

In addition, the foreign exchange management computer 1210 includes IDC account information management unit 1211 which manages user information of each country that has generated an international digital currency (IDC) dedicated account in the IDC account generation system 1100 and the generated IDC dedicated account information; an approval participant information management unit 1212 which manages information on countries connected to the IDC system for managing the selection of non-related persons to participate in whether or not to approve the exchange in relation to the exchange request of the user who requested the exchange, and information of users who have generated an International digital currency (IDC) dedicated account for each country; an exchange validity information management unit 1213 which generates and manages the validity information of the exchange request by integrating the exchange approval or rejection information of the predetermined number of countries and the predetermined number of participants selected by the approval participant information management unit 1212 for the exchange request; an exchange rate information management unit 1214 which collects and manages real-time exchange rate information provided by the financial institution systems 1230, 1240, and 1250 for each country; and an exchange ledger generation management unit 1215 which generates the exchange information of the user who made the exchange and the exchange approval details of the countries and participants participating in the decision-making on whether to approve the exchange request as an exchange ledger, stores the generated exchange ledger in the exchange data storage computer 1220, and stores, in a distributive manner, in the user terminal of the exchange applicant and non-related terminals, which are a predetermined number of participants among the participants who participated in the approval of the exchange application.

A user using the foreign exchange management system 1200 may perform an exchange into the currency of each country by using the existing account information held in the domestic financial institution in the state that the identity authentication is completed in the IDC account management system 1100.

The approval participant information management unit 1212 may further include an artificial intelligence computer for performing the number and selection of non-related persons who are not related to the country and the participant who will participate in decision-making related to the approval of the currency exchange application with artificial intelligence.

Here, a ‘non-related person’ who has no relationship with the applicant is a person who has no interest with the applicant, and in principle, there are no communication details such as text messages, messages, calls, and no e-mail, SNS exchange, or financial transaction. In addition, when all people are connected through a network or Internet network, it is desirable to select a person who is not directly communicated or exchanged as a non-related person because they are separated by a certain stage (eg, two stages) or more. The number of non-related persons can be initially set in the system for 100 or more people, and as the system is operated and data is accumulated, the artificial intelligence computers 1112 and 1360 can automatically determine the number of non-related persons.

The financial institution systems 1230, 1240, and 1250 for each country are configured as an example of country A among countries linked to the international digital currency system, a country A financial institution computer 1231 having a user's financial account and financial information in country A and performing financial transactions with the user and a country A exchange rate information providing unit 1232 for providing real-time an exchange rate information to the exchange management computer 1210. The country A exchange rate information providing unit 1232 may be configured as a separate computer or included in the country A financial institution computer 1231.

The user groups 2100, 2200, and 2300 for each country are configuration including, as an example of the user group 2100 of country A among users who have joined the international digital currency system and opened an international digital currency (IDC) dedicated account, a user terminal 2110 in country A used by a user who has an international digital currency (IDC) dedicated account opened in the international digital currency system and needs to be exchanged for another country's currency and a plurality of country A non-related person terminals 2120 used by non-related persons not related to the exchange applicant who are selected by the exchange management computer 1210 and make a decision on whether to approve the exchange of the exchange applicant when a currency exchange request is input to the user terminal 2110 of the country A.

The exchange management computer 1210 may store data such as exchange history information and exchange approval details of users linked to the international digital currency system in a storage space for each user provided by the cloud computing system 3000 or a user terminal.

Table 2 shows an example when a user of country A using the international digital currency system in the foreign exchange management system 1200 exchanges money with another country's currency.

TABLE 2

| | | | Currency exchange | |
|---|---|---|---|---|
| | | | amount of International | |
| | | Currency exchange | digital currency (IDC) | |
| Account information of | | application amount and | dedicated account by | |
| Country A financial institute | | exchange rate by country | country | Country |
| 100,000,000 | Currency of | 17,000(USD), 1,250:1 | 21,250,000 | US |
| | country A (eg, | | USD$17,000.00 | |
| | Korean currency | 15,000(EUR), 1300:1 | 19,500,000 | EP |
| | KRW) | | EUR15,000.00 | |
| | | 5,000(CNY), 175:1 | 875,000 | CN |
| | | | CNY5,000 | |

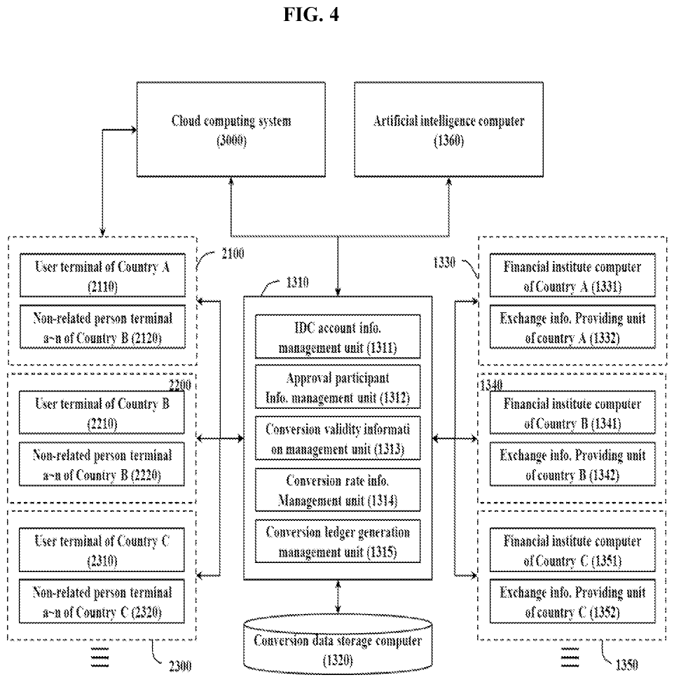

FIG. 4 is a schematic configuration diagram of an embodiment of the IDC conversion management system, which is a major part of the international digital currency operating system of the present invention.

As illustrated in FIG. 4, the IDC conversion management system 1300 of the present invention includes IDC conversion management computer 1310 which manages the conversion of the requested currency into international digital currency in response to a request for conversion of a specific currency (herein, the US dollar is used as the key currency) of a user who is an International digital currency (IDC) dedicated account holder for each country, a conversion data storage computer 1320 which is included in the IDC conversion management computer 1310 or is connected to a communication means, and stores various data such as a user international digital currency (IDC) dedicated account required for conversion to international digital currency and a standard conversion rate, and financial institution systems 1330, 1340 and 1350 for each country which provide information including financial accounts of users in each country who requested conversion to international digital currency and financial information necessary for conversion to international digital currency to the IDC conversion management computer 1310.

In addition, the international digital currency operating system of the present invention that is connected to the IDC conversion management computer 1310 is configuration further comprising user groups 2100, 2200, 2300 for each country, including user terminals used by the requestor for conversion to international digital currency in each country and non-related person terminals used by at least one non-related person not related to the requester, and a cloud computing system 3000 that is connected to the IDC conversion management computer 1310 and the user groups 2100, 2200, 2300 for each country and has a data storage space of the users for each country.

In addition, the IDC conversion management computer 1310 includes an IDC account information management unit 1311 which manages user information of each country that has generated an international digital currency (IDC) dedicated account in the IDC account generation system 1100 and holds international digital currency (IDC) dedicated account information, an approval participant information management unit 1312 which manages information on countries linked to the IDC system for managing the selection of countries and non-related persons in the country to participate in whether or not to approve the conversion in response to the user's request for conversion to international digital currency, and information about users who have generated an international digital currency (IDC) dedicated account for each country, a conversion validity information management unit 1313 which generates and manages a validity information of the conversion request by integrating information on the conversion approval or rejection of predetermined number of participant and country selected by the approval participant information management unit 1312 in order to process the conversion request of international digital currency, a conversion rate information management unit 1314 which manages conversion rate information of key currency and international digital currency that is set and stored in real time, and a conversion ledger generation management unit 1315 which generates conversion information of users who have converted to international digital currency and conversion approval details of a predetermined number of countries participating in the decision-making on whether to approve the conversion request and non-related persons who are participants as a conversion ledger, stores the generated conversion ledger in the conversion data storage computer 1320, and stores, in a distributive manner, the conversion ledger in the conversion request user terminal and non-related person terminals used by a predetermined number of participants among the participants participating in the approval of the conversion application.

The approval participant information management unit 1312 may further include an artificial intelligence computer 1360 for performing the number and selection of non-related persons not related to the applicant who is the country and participant who will participate in decision-making related to the approval of the conversion application with artificial intelligence.

The financial institution systems 1330, 1340, and 1350 for each country are configuration including, as an example of country A among countries linked to the international digital currency system, at least one country A financial institution computer 1331, 1332 having a user financial account and financial information of country A and performing financial transactions with the user.

The user groups 2100, 2200, and 2300 for each country include, for example of the country A user group 2100, a user terminal 2110 of country A used by a user applying for conversion who needs to convert from a key currency to an international digital currency among users who have joined the international digital currency system and opened an account dedicated to international digital currency (IDC), and a plurality of non-related terminals 2120 of country A selected by the IDC conversion management computer 1310 and used by non-related persons not related to the conversion applicant to make a decision on whether to approve the conversion of the conversion applicant regarding the application for conversion of the user terminal 2110 of country A.

The IDC conversion management computer 1310 may use a storage space of each user by provided the cloud computing system 3000 or a storage space set in the user terminal as a space to store data, for example, international digital currency conversion history information and conversion approval details, etc.

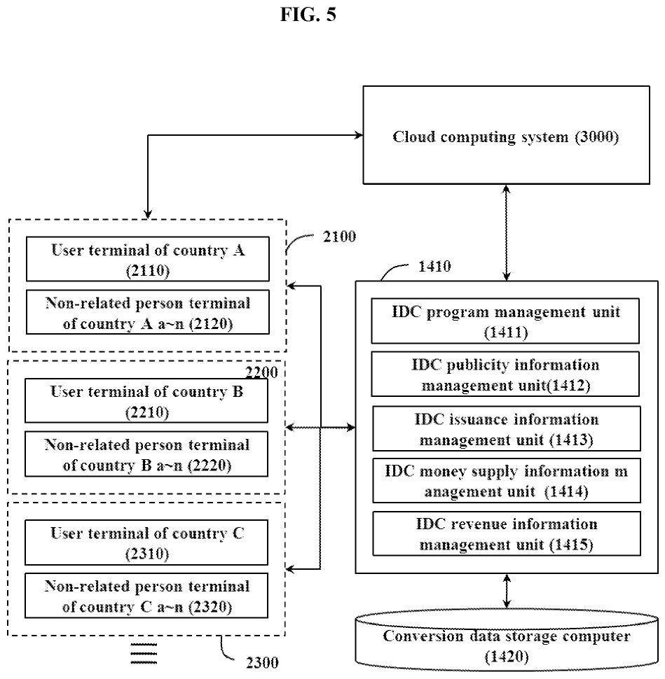

FIG. 5 is a schematic diagram illustrating an embodiment of an IDC management system, which is a specification of an operation system of the International digital currency of the present invention.

As illustrated in FIG. 5, the IDC management system 1400 of the present invention includes an IDC program management unit 1411 which manages users and user terminal information of each country using the IDC system, and upgrades and uses web programs, application programs and cloud computer programs used in the IDC system, an IDC publicity information management unit 1412 which manages guide information and publicity information provided to the IDC user interface of the user terminal of the user groups 2100, 2200, 2300 of each country, an IDC issuance information management unit 1413 which manages the issuance information of international digital currency, including conversion information of the key currency into international digital currency and additional issuance of profit-type international digital currency, an IDC money supply information management unit 1414 which adjusts the money supply of the entire international digital currency in relation to the issuance, circulation and conversion of international digital currency; and an IDC revenue information management unit 1415 which sets and stores the profit information provided to the conversion requester, non-related persons in each country participating in the approval of the conversion application, and the IDC system, when users in each country convert their key currency into international digital currency.

With reference to the embodiment of the present invention of FIGS. 1 to 5 described above, a more detailed description will be given in relation to the operation of the international digital currency system of the present invention.

Users of each country who want to use the international digital currency system of the present invention access the IDC account creation system 1100 through a user terminal, and apply for membership through identity authentication.

The IDC account creation system 1100, which has received the membership application, performs identity authentication as to whether the user is correct based on the information collected from the SNS system with related persons such as the applicant's acquaintances based on the applicant information, and performs user authentication of the applicant.

A user whose user authentication has been completed applies to open an international digital currency (IDC) dedicated account for each country for foreign exchange and use of international digital currency to the IDC account generation system 1100 in order to use the international digital currency system. The IDC account generation system 1100, which received the application for an international digital currency (IDC) dedicated account, generates and stores an international digital currency (IDC) dedicated account for each country in connection with user information, and transmits the international digital currency (IDC) dedicated account information opened to the user terminal that has applied for it.

In the state that the International digital currency (IDC) dedicated account receives the approval of linkage with the existing financial account at the domestic financial institution, or is automatically linked, the user terminal accesses the IDC conversion management system 1300 and applies for conversion of a predetermined amount of financial information stored in an international digital currency (IDC) dedicated account into international digital currency. The IDC conversion management system 1300, if the currency for which the request for conversion to the international digital currency is not a set key currency, converts it into a key currency using the foreign exchange management system 1200, and based on the exchanged key currency conversion to international digital currency. The IDC conversion management system 1300 selects a set number of countries from among the countries linked to the IDC system, for validation of the conversion to international digital currency, and extracts participant information as non-related persons in the selected country. Here, preferably, information of a set number of participants among users who opened an international digital currency (IDC) dedicated account in the IDC system is extracted.

By providing the international digital currency (IDC) dedicated account information within the limited information of the applicant who applied for the conversion to the international digital currency to the extracted participants from each country, check whether the conversion amount of the conversion applicant is correct, and if it is confirmed that there is no problem in the conversion details, the applicant's conversion to international digital currency may be approved.

At this time, the method of verifying the validity of the conversion by the non-related person participant is to be calculated using a calculation program in the terminal of the non-related participant, a calculation-related utility provided from the cloud computing system 3000, or a calculation program built into the IDC systems. In addition, the exchange rate information can be checked and verified by accessing the internet network and inquiring and calculating the exchange rate at the time of conversion request or verification in real time.

In this case, it is desirable to exclude the country to which the applicant for international digital currency conversion belongs in the selection of participants.

However, in the early stage when the use of this system has not been established internationally, it may be a practical application of this system to include some participants from the country to which the conversion applicant belongs and to gradually reduce the proportion of participants from the country to which the conversion requester belongs.

The present invention selects n or more countries among countries excluding the applicant's country, selects k or more of the total number of international digital currency (IDC) dedicated account openers in the selected n countries, and makes a decision on whether to approve the applicant's application for conversion.

Here, the numerical value of n of countries participating in approval is set by the IDC system operator, for example, 10 countries, and the number of participants in approval k is set to 100. Preferably, the artificial intelligence computer may analyze the data value to calculate and apply a numerical value optimized for manipulation prevention.

The IDC system and artificial intelligence computer randomly select the nationality of approved participants and the number of people per country, but it can be set so that the number of participants is not excessively assigned to a specific country.

The IDC management system 1400 may provide profits to a conversion applicant f to international digital currency and a non-related person participating in the approval of the conversion application.

The amount of international digital currency set in the standard conversion rate may be additionally paid to the applicant who applied for conversion of the key currency to the international digital currency. For example, if the key currency is USD, if you additionally pay 1 international digital currency (hereinafter referred to as “DC”) when applying for USD 100 conversion (assuming that the conversion rate based on international digital currency is 1:1), It can be configured to be converted to DC 101 in the international digital currency (IDC) dedicated account of the conversion applicant and to reduce 100 dollars as soon as the international digital currency is deposited.

Here, the ‘conversion rate’ when converting the key currency into international digital currency is explained on the premise that it is set to 1:1 for convenience. However, other internationally agreed rates may be applied for the purpose of adjusting the issuance volume or resetting or adjusting the exchange value in consideration of the social and economic functions of money.

In addition, for the distribution of profits to non-related persons in each country who approved and participated in the application for international digital currency conversion, the amount of the specified international digital currency is additionally calculated from the converted international digital currency, and the amount is equally distributed to the approved participants. For example, when DC 100 is converted, DC 1 is additionally issued and if there are 100 approved participants, DC 0.01 can be credited to the International digital currency (IDC) dedicated account of approved participants, etc.

The amount of additional international digital currency paid to the applicants for the conversion to the international digital currency and the participants for approval is, if you want to link the value of goods to the amount of profit provided, post advertisements, etc. It may be configured to be procured by making payment. In this case, the value of the goods is tied to the amount of profit provided.

In this case, it can be considered that international digital currency has been additionally paid or issued as much as the value (fees, etc.) created by the advertisement posting.

When it is necessary to control the amount of international digital currency, it can be performed by increasing or decreasing the evaluation amount by setting the evaluation balance of the entire international digital currency (IDC) dedicated account as the reference point at a specific time.

When an increase or decrease in the amount of money is performed, it can be adjusted to increase or decrease the amount of international digital currency in the entire International digital currency (IDC) dedicated account.

The profit rate provided to the applicant for the conversion to the international digital currency and the approval participant, the adjustment rate when adjusting the money supply of the international digital currency, and the conversion rate of the key currency to the international digital currency may be used to calculate using the numerical determination system (Patent No. 10-1998825) of the present applicant.

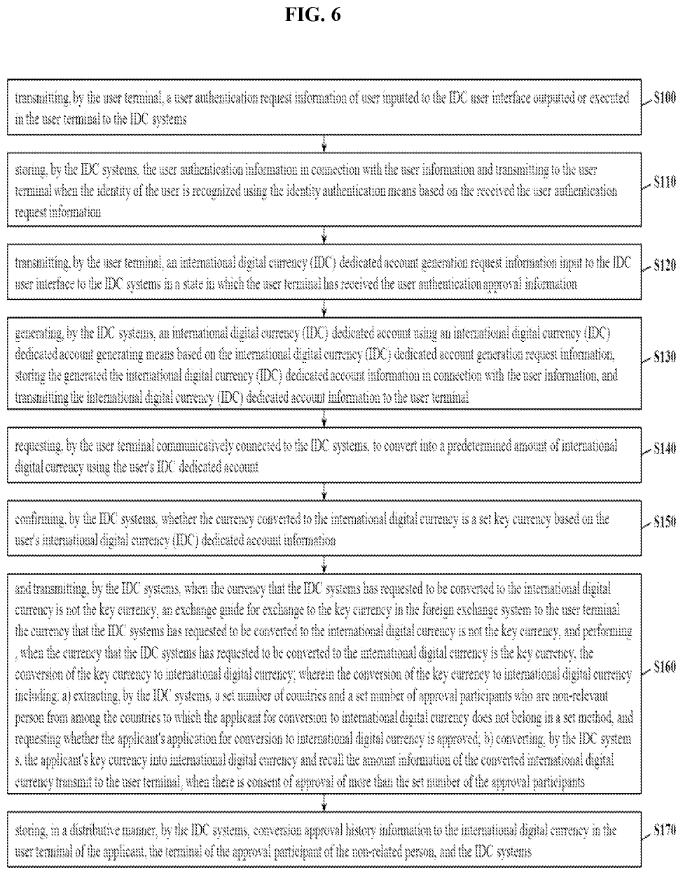

FIG. 6 is a flowchart illustrating an operating method of the international digital currency according to an embodiment of the present invention.

As illustrated in FIG. 6, the operating method of the international digital currency comprising: transmitting, by the user terminal, a user authentication request information of user inputted to the IDC user interface outputted or executed in the user terminal to the IDC systems (S100); storing, by the IDC systems, the user authentication information in connection with the user information and transmitting to the user terminal when the identity of the user is recognized using the identity authentication means based on the received the user authentication request information (S110); transmitting, by the user terminal, an international digital currency (IDC) dedicated account generation request information input to the IDC user interface to the IDC systems in a state in which the user terminal has received the user authentication approval information (S120); generating, by the IDC systems, an international digital currency (IDC) dedicated account using an international digital currency (IDC) dedicated account generating means based on the international digital currency (IDC) dedicated account generation request information, storing the generated the international digital currency (IDC) dedicated account information in connection with the user information, and transmitting the international digital currency (IDC) dedicated account information to the user terminal (S130); requesting, by the user terminal communicatively connected to the IDC systems, to convert into a predetermined amount of international digital currency using the user's IDC dedicated account (S140); confirming, by the IDC systems, whether the currency converted to the international digital currency is a set key currency based on the user's international digital currency (IDC) dedicated account information (S150); and transmitting, by the IDC systems, when the currency that the IDC systems has requested to be converted to the international digital currency is not the key currency, an exchange guide for exchange to the key currency in the foreign exchange system to the user terminal the currency that the IDC systems has requested to be converted to the international digital currency is not the key currency, and performing, when the currency that the IDC systems has requested to be converted to the international digital currency is the key currency, the conversion of the key currency to international digital currency; wherein the conversion of the key currency to international digital currency including: a) extracting, by the IDC systems, a set number of countries and a set number of approval participants who are non-relevant person from among the countries to which the applicant for conversion to international digital currency does not belong in a set method, and requesting whether the applicant's application for conversion to international digital currency is approved; b) converting, by the IDC systems, the applicant's key currency into international digital currency and recall the amount information of the converted international digital currency transmit to the user terminal, when there is consent of approval of more than the set number of the approval participants (S160); and storing, in a distributive manner, by the IDC systems, conversion approval history information to the international digital currency in the user terminal of the applicant, the terminal of the approval participant of the non-related person, and the IDC systems (S170).

In addition, calculating the profit information to be provided to the applicant for conversion to international digital currency and the non-related approved participant by the IDC systems, and storing or accumulating the calculated profit information in connection with the information of the conversion applicant and the approved participant is further may include.

According to the embodiment of the present invention described above, using international digital currency, profits are generated according to the exchange rather than the fee according to the existing exchange around the world is paid, and the profits are also returned to the participants of the countries participating in the approval, It is possible to achieve vitalization of the use of international digital currency.

The embodiments of the present invention described above are only some of the various embodiments. In the conversion of the key currency of the present invention to international digital currency that can be used between countries, various embodiments including technical idea that performs conversion from a key currency to an international digital currency by receiving approval information from participants in a set number of countries and selected countries for validating the validity of a conversion application, and provides benefits to conversion applicants and approval participants fall within the protection scope of the present invention.

1. An international digital currency (IDC) conversion management computer comprising:
at least one hardware processor and a memory storing a program for converting the specific currency into international digital currency that causes the computer to perform:
receiving, by at least one hardware processor of the IDC conversion management computer, an application for conversion of a specific currency to international digital currency input into an international digital currency dedicated account of a user;
selecting, by at least one hardware processor of the IDC conversion management computer, a predetermined number of countries in relation to the application for conversion of the user; and
performing, by at least one hardware processor of the IDC conversion management computer, a conversion of the specific currency to the international digital currency based on verification information of the validation of the application for conversion provided from a predetermined number of non-related person approval participants of the selected countries.

2. The IDC conversion management computer of claim 1, wherein the verification of the validity of the application for conversion extracts information of non-related persons not related to the user in the selected countries, selects a predetermined number of non-related persons among the extracted non-related persons as a non-related person approval participant for participating in the decision-making on whether to approve a conversion of the international digital currency, and performs the conversion based on the decision on whether to approve the conversion of the international digital currency provided by the selected non-related person approval participants.

3. The IDC conversion management computer of claim 1, wherein when the specific currency for which the user applied for conversion to international digital currency is not the key currency, the IDC conversion management computer exchanges the specified currency into the key currency by applying the exchange rate related to the key currency or receives information on the exchanged key currency.

4. An operating system for international digital currency (IDC), comprising:
an account generation management computer which receives information on identity verification of the user himself/herself by related persons including the user's acquaintances, performs user authentication the user based on the determination of consistency between the data representing the relationship between the person analyzed in the communication details between the user and the related persons and the data representing the relationship between people that it owns, receives an application for opening an international digital currency dedicated account for each country used between countries of the user whose user authentication has been completed, and generates the international digital currency dedicated account for each country of the user; and
an IDC conversion management computer which selects a predetermined number of countries by receiving an application for conversion of a specific currency into international digital currency in the account of the international digital currency for each country, performs conversion of the specific currency to international digital currency based on a verification of the validity of the application for conversion by a predetermined number of non-related person approval participants in the selected country; and stores, in a distributive manner, data storage space of the user terminal used by the user who is the applicant for conversion of international digital currency and the data storage space of the non-related person terminal used by the non-related person who is a participant in the approval of the application for conversion.

5. The operating system of claim 4, wherein the verification of the validity of the application for conversion extracts information of non-related persons not related to the user in the selected countries, selects a predetermined number of non-related persons among the extracted non-related persons as a non-related person approval participant for participating in the decision-making on whether to approve a conversion of the international digital currency, and performs the conversion based on the decision on whether to approve the conversion of the international digital currency provided by the selected non-related person approval participants.

6. An operating method for international digital currency (IDC), comprising:
receiving, by an IDC conversion management computer, an application for conversion of a specific currency into an international digital currency input into an international digital currency dedicated account of user; and
selecting, by the IDC conversion management computer, a predetermined number of countries and performing the conversion of the specific currency to international digital currency based on a verification of the validity of the application for conversion by a predetermined number of non-related person approval participants in the selected countries.

7. The operating method of claim 6, wherein the verification of the validity of the application for conversion extracts information of non-related persons not related to the user in the selected countries, selects a predetermined number of non-related persons among the extracted non-related persons as a non-related person approval participant for participating in the decision-making on whether to approve a conversion of the international digital currency, and performs the conversion based on the decision on whether to approve the conversion of the international digital currency provided by the selected non-related person approval participants.

8. An operating method for international digital currency (IDC), comprising:
transmitting, by a user terminal, a request for user authentication of user inputted to an IDC user interface outputted or executed in the user terminal to IDC systems;
performing, by the IDC systems, an identity authentication of the user based on the user authentication request information of the user received using an identity authentication means, storing a user authentication approval information of the user in association with the user information, and transmitting the user authentication approval information to the user terminal;
transmitting, by the user terminal, IDC account generation request information input to the IDC user interface to the IDC systems in a state that the user terminal has received the user authentication approval information;
generating, by the IDC systems, an IDC account using an IDC account generating means based on the IDC account generation request information received, storing the IDC account in association with user information, and transmitting the IDC account information to the user terminal;
communicating, by the user terminal, with the IDC systems and applying to the IDC systems for conversion of a predetermined amount into international digital currency using the user's IDC account;
confirming, by the IDC systems, through the IDC account information of the user, whether the currency requested to be converted into an international digital currency is a set key currency;
transmitting, by the IDC systems, when the currency requested to be converted into an international digital currency is not the key currency, an exchange guide to the key currency in a foreign exchange system to the user terminal, and when it is the key currency, converting the key currency to international digital currency; and
storing, in a distributive manner, by the IDC systems, a conversion approval details information to the international digital currency in the user terminal of the user who is the applicant, the non-related person terminals of those participating in the conversion approval to the international digital currency and the IDC systems.

9. The operating method of claim 8, wherein the converting of the key currency to the international digital currency includes:
selecting, by the IDC systems, a set number of countries from among the countries to which the conversion applicant does not belong, extracting a set number of non-related person approval participants from selected countries in a set way, requesting whether the user's application for conversion to international digital currency is approved to the extracted non-related person approval participants,
receiving, by the IDC systems, reply information of the non-related person approval participants, converting the applicant's key currency into international digital currency by receiving approval consent of more than the set number of the non-related person approval participants.
